(19) United States
(12) Patent Application Publication
(10) Pub. No.: US 2001/0005480 A1
(43) Pub. Date: Jun. 28, 2001

(54) Apparatus and methods for relieving thermally induced stresses in inner and outer bands of thermally cooled turbine nozzle stages

(76) Inventors: Yufeng Phillip Yu, Guilderland, NY (US); Gary Michael Itzel, Clifton Park, NY (US); Victor H. S. Correia, Milton Mills, NH (US)

Correspondence Address: NIXON & VANDERHYE P.C., 8th Floor, 1100 North Glebe Road, Arlington, VA, 22201, US

(21) Appl. No.: 09/761,635

(22) Filed: Jan. 18, 2001

Related U.S. Application Data
(63) Continuation of application No. 09/311,640, filed on May 14, 1999.

(51) Int. Cl. F01D 9/06; F01D 5/08; F01D 5/18; F03D 11/00; F03B 11/00; F01D 11/00; F01D 25/08; F01D 25/16; F01D 25/18; F04D 29/04

(52) U.S. Cl. 415/115; 415/116; 415/175; 415/176

(57) ABSTRACT

To control the temperature mismatch between the inner and outer bands and covers forming plenums with the inner and outer bands on sides thereof remote from the hot gas path, passages extend from the leading edge of the covers in communication with the hot gases of combustion to the trailing edge of the covers in communication with the hot gas flowpath. A mixing chamber is provided in each passage in communication with compressor discharge air for mixing the hot gases of combustion and compressor discharge air for flow through the passage, thereby heating the cover and minimizing the temperature differential between the inner and outer bands and their respective covers. The passages are particularly useful adjacent the welded or brazed joints between the covers and inner band portions.

### TECHNICAL FIELD

The present invention relates generally to gas turbines having closed cooling circuits in one or more nozzle stages and particularly relates to reducing thermally induced stresses in the inner and outer bands of the nozzle stages caused by temperature differentials between the hot gases of combustion flowing along the hot gas path and the cooling medium.

### BACKGROUND OF THE INVENTION

In industrial or land-based gas turbines, one or more of the nozzle stages are cooled by passing a cooling medium from a plenum in each nozzle segment portion forming part of the outer band through one or more nozzle vanes to cool the nozzles and into a plenum in the corresponding inner band portion. The cooling medium then flows radially outwardly from the inner band portion, again through the one or more nozzle vanes for discharge. Typically, the cooling medium is steam. Each of the nozzle segments including the inner and outer band portions and one or more nozzle vanes are typically cast. Covers are applied to the inner and outer band portions on sides thereof remote from the hot gas path to define plenums for receiving the cooling medium. The covers are not cast with the nozzle segments. Rather, they are preferably later applied to the inner and outer band portions, for example, by welding or brazing. With this arrangement, the hot gas flowpath sides of the bands are exposed to relatively high temperatures, while the covers which are not directly exposed to the hot gases of combustion along the flowpath, remain considerably cooler. Additionally, the covers are exposed externally to compressor discharge air which, while having a temperature higher than the temperature of the steam cooling medium is still considerably less than the temperature of the inner and outer bands exposed to the hot gases of combustion. The temperature differential between the covers and the band portions, particularly along the weld lines between the covers and walls of the band portions exposed to the hot gas path cover results in high thermal stresses. As a consequence, there is a need to reduce the thermally induced stresses along the inner and outer bands of the nozzle stages caused principally by temperature differentials between the hot gases of combustion in the hot gas path, the cooling medium flowing through the inner and outer bands and the compressor discharge air.

### BRIEF SUMMARY OF THE INVENTION

In accordance with a preferred embodiment of the present invention, the temperature difference between the flowpath exposed surfaces of the inner and outer bands and the covers exposed both to the cooling medium and the compressor discharge air is reduced by flowing a thermal medium along the covers at a temperature intermediate the temperature of the hot gases of combustion and the cooling medium through the cover and particularly adjacent the joints between the covers and the nozzle bands. The thermal medium flowing along the covers is at a significantly higher temperature than the temperatures of the cooling medium and the compressor discharge air in order to heat the cover so that the cover temperature approaches the bulk temperature of the flowpath exposed surfaces of the nozzle bands. To provide such thermal medium, a portion of the combustion path gases are directed through entry ports at the leading edges of the cover. Those gases follow passages through the cover and distribute heat substantially evenly to the cover for exit at the trailing edges of the covers into the hot gas path. Because of their very high temperature, flowpath gases alone can cause damage to the cover by way of oxidation, elevation of the bulk temperature of the covers in excess of that of the flowpath surfaces, and a reverse temperature gradient, resulting in similar high thermal stresses. To optimize the temperature of the thermal medium flowing through the heating passages in the covers, hot gases of combustion are combined with high pressure compressor discharge air for flow through the one or more passages in the cover. By providing one or more metering apertures in communication with compressor discharge air and with the passage(s) through the covers, hot flowpath gases entering the passage(s) are combined with compressor discharge air. This results in a thermal medium having a temperature sufficiently high to heat the cover adequately to reduce thermal stresses while avoiding the aforementioned and other problems.

Also, and advantageously, the mixture of hot combustion gases and compressor discharge air is (i) lower in pressure than both the compressor discharge air and hot gases of combustion at the leading edge of the passages and (ii) higher than the pressure of the hot gases of combustion at the trailing edge of the cover. Thus, the cooling medium flows passively through the passages between the leading edges to the trailing edges of the nozzle segments. The result is a cover having a temperature very close to the bulk temperature of the hot gas flowpath surfaces, thus reducing the thermal stresses induced by the thermal mismatch and affording higher component life and more reliable joints.

In a preferred embodiment according to the present invention, there is provided apparatus for controlling a temperature mismatch in at least one of the inner and outer bands of turbine nozzles having cooling circuits for flowing a cooling medium, comprising a nozzle segment having at least one nozzle vane and inner and outer nozzle band portions adjacent opposite ends of the nozzle vane and in part defining a path for flowing hot gases of combustion, one of the band portions forming a wall exposed to the hot gas path of the turbine and having a cover on a side of the wall remote from the hot gas path, the cover and the wall defining a plenum therebetween for receiving the cooling medium forming part of the cooling circuit, the segment including at least one passage through the cover for flowing a thermal medium at a temperature intermediate the temperature of the cooling medium and the hot gases of combustion to reduce the temperature differential between the cover and the wall and thereby reduce thermal-induced stresses in the one band portion.

In a further preferred embodiment according to the present invention, there is provided apparatus for controlling a temperature mismatch in at least one of inner and outer bands having a turbine nozzle vane therebetween and a cooling circuit for flowing a cooling medium through the nozzle vane, comprising a nozzle segment having at least one nozzle vane and inner and outer nozzle band portions adjacent opposite ends of the nozzle vane and in part defining a path for flowing hot gases of combustion, one of the band portions forming a wall exposed to a hot gas path of the turbine and having a cover on a side of the wall remote from the hot gas path, the cover and the wall, defining a plenum therebetween for receiving the cooling medium forming part of a nozzle cooling circuit, the cover and the wall of the band forming joints therebetween and along opposite sides thereof, the segment including passages through the cover from adjacent a leading edge to a trailing edge thereof and adjacent the joints for flowing the medium at a temperature intermediate the temperature of the cooling medium and the hot gases of combustion to reduce the temperature differential between the cover and the wall in the region of the joints to reduce thermal induced stresses in the one portion.

In a still further preferred embodiment according to the present invention, there is provided a method of reducing a temperature differential between a wall of an inner or an outer band of a turbine nozzle segment having a vane between the walls and a cover on a side of the wall remote from a flowpath for hot gases of combustion past the nozzle wherein the wall and cover define a plenum therebetween for receiving a cooling medium for flow through the nozzle vane, comprising the steps of flowing a thermal medium through at least one passage in the cover at a temperature intermediate respective temperatures of the hot gases of combustion and the cooling medium to elevate the temperature of the cover.

### BRIEF DESCRIPTION OF THE DRAWINGS

FIG. 1 is a fragmentary cross-sectional view illustrating a nozzle stage for a gas turbine incorporating the present invention;

FIG. 2 is an enlarged fragmentary cross-sectional view illustrating a leading edge of the inner band portion of a nozzle segment;

FIGS. 3 and 4 are perspective schematic illustrations of covers for the inner or outer band segments; and

FIG. 5 is a fragmentary cross-sectional view of an inner band segment portion illustrating the thermal medium passages.

### DETAILED DESCRIPTION OF THE INVENTION

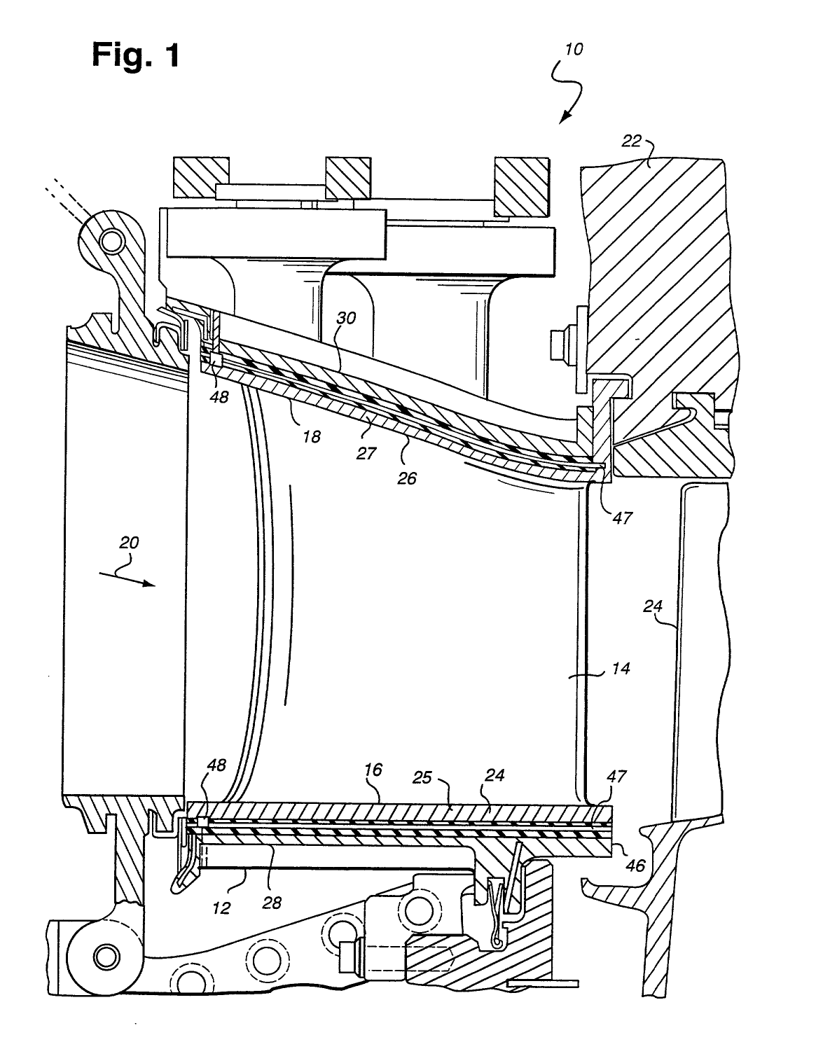

Referring now to the drawings, particularly to FIG. 1, there is illustrated a nozzle stage, generally designated 10, comprised of a plurality of nozzle segments arranged circumferentially about the axis of the turbine. Each of the nozzle segments 12 includes one or more nozzle vanes 14 disposed between inner and outer band portions 16 and 18, respectively. It will be appreciated that the inner and outer band portions 16 and 18 and nozzle vanes 14 define a flowpath for hot gases of combustion flowing in the direction of the arrow 20. The nozzle segments are circumferentially arrayed about the turbine axis and secured to a fixed shell 22. Additionally illustrated in FIG. 1 is one of a plurality of circumferentially spaced buckets 24 forming part of the rotor of the turbine, it being appreciated that the hot gases of combustion flow through the buckets and rotate the rotor.

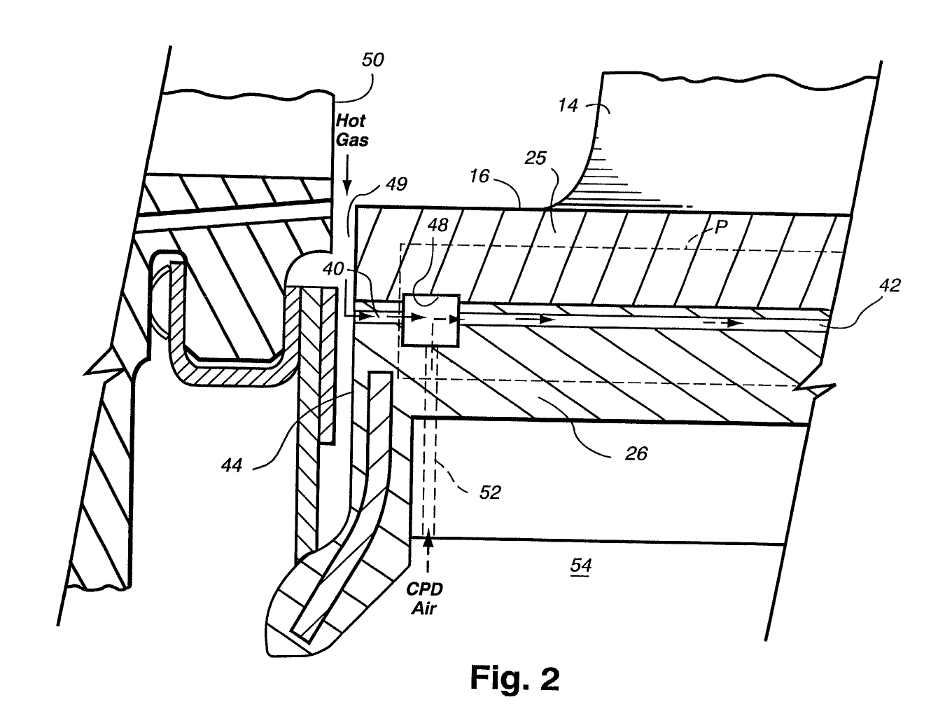

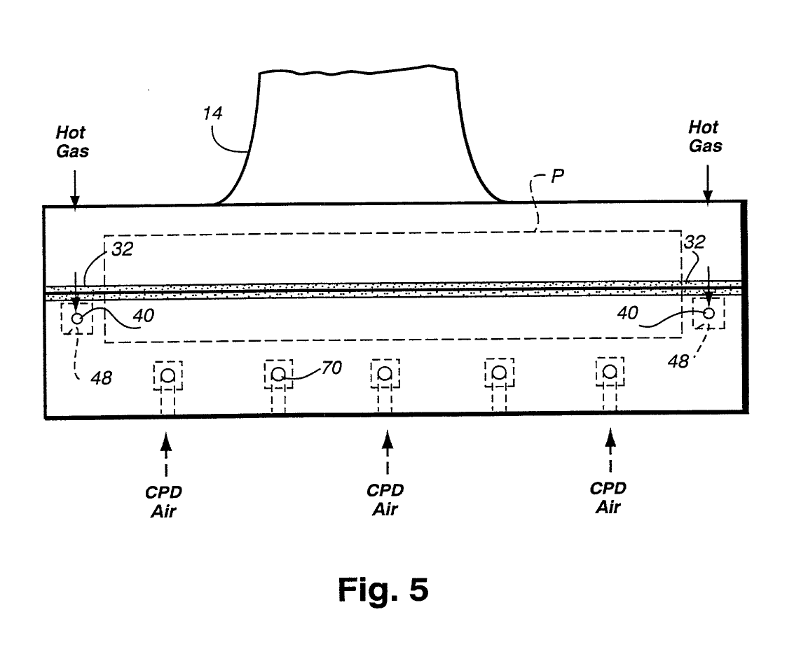

The inner and outer band portions 24 and 26, respectively, are comprised of inner and outer walls 25 and 27, respectively, exposed to the hot gases of combustion in flowpath 20 and inner and outer covers 28 and 30. The covers define with the walls plenums P for receiving a cooling medium, one plenum P being illustrated in FIG. 2 by the dashed lines. Particularly, the cooling medium is supplied to the outer wall plenum for impingement cooling of the radial outer band portion and for flow through the vane 14 into a plenum in the inner band portion. The cooling medium flows into the latter plenum for impingement cooling of the inner band wall and for discharge through radially outwardly extending passages through the vane 14 for return. It will be appreciated that the nozzle segment may be cast, for example, from a nickel alloy material. The covers 28 and 30 are secured to the walls of the cast nozzle segments to define the plenums, preferably by welded or brazed joints 32, illustrated in FIG. 5. Referring back to FIG. 1, the walls of the inner and outer band portions are, of course, exposed to the high temperature of the hot gases of combustion flowing along the flowpath 20, while the covers 28 are exposed to compressor discharge air on sides thereof remote from the walls. The compressor discharge air is, of course, at a lower temperature than the hot gases of combustion. Additionally, the cooling medium supplied to the nozzle via the plenums is at a temperature intermediate the temperature of the compressor discharge air and the hot gases flowing along flowpath 20. As noted previously, this causes a thermal mismatch between the cover and the inner and outer band portions, causing thermal stresses in the inner and outer band segments. The present invention minimizes or eliminates those thermal stresses by elevating the temperature of the cover to a temperature closer to the temperature of the inner and outer walls and intermediate the bulk temperature of the walls and the temperature of the cooling medium.

To accomplish the foregoing, and referring to FIGS. 1 and 2, each cover has at least one passage and preferably a pair of passages 42 extending from its leading edge to its trailing edge for flowing a thermal, i.e., a heating medium to heat the cover and raise its temperature to approximate the bulk temperature of the wall. Referring to FIG. 2 and the inner band portion 16, the cover 26 includes at least one entry port 40 to each passage 42 which extends between the leading and trailing edges 44 and 46, respectively, of the cover to an exit port 47. A mixing chamber 48 is disposed in each passage 42 adjacent the leading edge 44. As best illustrated in FIG. 2, a slot 49 is formed between the leading edge of the nozzle segment and the adjoining structure 50 to permit passage of hot gases flowing along the hot gas path to enter the entry port 40 of the passage 42. Additionally, a passage 52 extends through the cover and lies in communication at respective opposite ends with the mixing chamber 48 and an area 54 containing compressor discharge air. Consequently, both hot gases of combustion and compressor discharge air are supplied to the mixing chamber 48 and mixed to provide a thermal medium having a temperature sufficient to raise the temperature of the cover to approximate the bulk temperature of the wall.

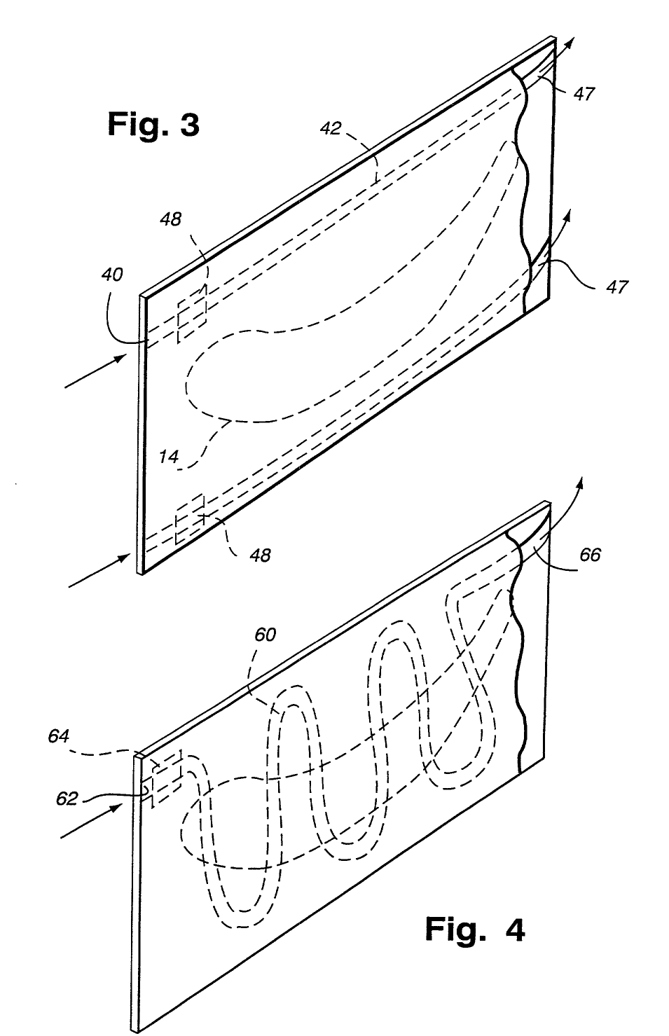

As best illustrated in FIGS. 3 and 5, an entry port 40 and passage 42 are located directly adjacent each joint between the cover and the wall along opposite sides of the cover. Additional passages 42, entry ports 40, mixing chambers 48 and exit ports 47 may also be provided through the covers from their leading edges to their trailing edges between the opposite sides of the covers. These additional passages therefore similarly heat the cover between opposite sides thereof, with the mixture of hot combustion gases and compressor discharge air. Referring to FIGS. 3 and 4, there is schematically illustrated a pair of covers which are useful with either the inner or outer band portions. In FIG. 3, for example, the inner cover 28 includes the passages 42 adjacent opposite side edges, the outline of the vane 14 being superimposed by the dashed lines on the illustrated cover. It will be seen that the exit port 47 of each passage 42 is angled at substantially the same angle as the hot gases of combustion flow from the trailing edge of the vane. It will be appreciated that the passages 42 illustrated in FIG. 3 lie along opposite sides of the cover directly adjacent the joints between the covers and the band portion 16.

In FIG. 4, the entirety of the cover is heated by the mixed hot gases of combustion and compressor discharge air. In this form, a serpentine passage 60 is provided through the cover. As in the prior embodiment, the entry port 62 directs hot gases of combustion into the mixing chamber 64. The combined hot gases and compressor discharge air then flow along passage 60 and into the hot gas stream via exit port 66. The exit port 66 is angled at substantially the same angle as the angle of the trailing edge of the vane so that the exiting thermal medium flows in substantially the same direction as the hot gases of combustion leaving the trailing edge of the vane.

It will be appreciated that the radial outer band portion is similarly configured as the inner band portion just described. That is, the outer band portion similarly includes entry ports adjacent opposite sides of the outer band portion in communication with mixing chambers adjacent the leading edge for mixing compressor discharge air and hot gases of combustion for flow through passages along the opposite edges of the cover and into the hot gas path adjacent the trailing edge of the outer cover.

From the foregoing, it will be appreciated that the temperature of the covers is heated by the mixture of the hot gases of combustion and compressor discharge air to a temperature which heats the covers to approximate the bulk temperature of the wall of the inner or outer band portions. Consequently, the temperature differential between the covers and the inner and outer wall band portions is substantially reduced sufficiently to minimize or eliminate thermal stresses. It will also be appreciated that a substantial number of passages may be disposed through each of the covers, substantially paralleling the pair of passages along opposite sides of the covers. For example, as illustrated in FIG. 5, the entry apertures for flowing hot gases of combustion into a plurality of mixing chambers within the cover and mixing the hot gases of combustion with compressor discharge air via passages 70 is illustrated. Thus, the entirety of the cover can be heated. Also, the pressure of the hot gases of combustion and compressor discharge air at the leading edge is greater than the pressure of the flowpath at the trailing edge. In this manner, the flow of the mixed gases does not require pumping and the gases flow passively to heat the covers.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. Apparatus for controlling a temperature mismatch in at least one of the inner and outer bands of turbine nozzles having cooling circuits for flowing a cooling medium, comprising:
a nozzle segment having at least one nozzle vane and inner and outer nozzle band portions adjacent opposite ends of said nozzle vane and in part defining a path for flowing hot gases of combustion;
one of said band portions forming a wall exposed to said hot gas path of said turbine and having a cover on a side of said wall remote from said hot gas path, said cover and said wall defining a plenum therebetween for receiving the cooling medium forming part of the cooling circuit;
said segment including at least one passage through said cover for flowing a thermal medium at a temperature intermediate the temperature of the cooling medium and the hot gases of combustion to reduce the temperature differential between said cover and said wall and thereby reduce thermal-induced stresses in said one band portion.

2. Apparatus according to claim 1 wherein said one passage lies in communication with the hot gases of combustion flowing along said flowpath.

3. Apparatus according to claim 1 wherein said one passage lies in communication with compressor discharge air on a side of said cover opposite said wall.

4. Apparatus according to claim 1 wherein said one passage lies in communication with the hot gases of combustion and compressor discharge air on a side of said cover opposite said wall.

5. Apparatus according to claim 1 wherein said one passage includes a mixing chamber adjacent a leading edge portion of the one nozzle band portion for mixing hot gases of combustion and compressor discharge air and flowing the mixed hot gases in combustion and compressor discharge air along said one passage.

6. Apparatus according to claim 1 wherein said one passage has an exit opening angled to direct the thermal medium at substantially the same angle as the hot gases of combustion exit a trailing edge of said one nozzle vane.

7. Apparatus according to claim 1 wherein said one passage extends in a generally serpentine manner between opposite side edges of said one band portion from a leading edge to a trailing edge thereof.

8. Apparatus according to claim 1 wherein said cover and said wall of said one band portion form joints therebetween along opposite sides of said segment, said one passage extending adjacent one said joint along one side of said segment and a second passage extending adjacent a second joint along said opposite side of said segment for flowing said thermal medium thereby to reduce the temperature differential between said cover and said wall along said joints.

9. Apparatus for controlling a temperature mismatch in at least one of inner and outer bands having a turbine nozzle vane therebetween and a cooling circuit for flowing a cooling medium through the nozzle vane, comprising:
a nozzle segment having at least one nozzle vane and inner and outer nozzle band portions adjacent opposite ends of said nozzle vane and in part defining a path for flowing hot gases of combustion;
one of said band portions forming a wall exposed to a hot gas path of the turbine and having a cover on a side of said wall remote from the hot gas path, said cover and said wall, defining a plenum therebetween for receiving the cooling medium forming part of a nozzle cooling circuit, said cover and said wall of said band forming joints therebetween and along opposite sides thereof;
said segment including passages through said cover from adjacent a leading edge to a trailing edge thereof and adjacent said joints for flowing the medium at a temperature intermediate the temperature of the cooling medium and the hot gases of combustion to reduce the temperature differential between said cover and said wall in the region of the joints to reduce thermal induced stresses in said one portion.

10. Apparatus according to claim 9 wherein said passages lie in communication with the hot gases of combustion flowing along said path and compressor discharge air on one side of said cover opposite said wall.

11. Apparatus according to claim 9 wherein each said passage includes a mixing chamber adjacent a leading edge portion of the one nozzle band portion for mixing hot gases of combustion and compressor discharge air and flowing the mixed hot gases of combustion and compressor discharge air along said passages.

12. A method of reducing a temperature differential between a wall of an inner or an outer band of a turbine nozzle segment having a vane between said walls and a cover on a side of the wall remote from a flowpath for hot gases of combustion past said nozzle wherein the wall and cover define a plenum therebetween for receiving a cooling medium for flow through the nozzle vane, comprising the steps of:
flowing a thermal medium through at least one passage in said cover at a temperature intermediate respective temperatures of said hot gases of combustion and said cooling medium to elevate the temperature of the cover.

13. A method according to claim 12 including flowing hot gases of combustion through said passage.

14. A method according to claim 12 including flowing compressor discharge air through said passage.

15. A method according to claim 12 including flowing hot gases of combustion and compressor discharge air through said passage.

16. A method according to claim 12 including mixing hot gases of combustion and compressor discharge air in a mixing chamber adjacent a leading edge of the wall to form the thermal medium and flowing the mixture from adjacent said leading edge along said passage to a trailing edge of said wall.

17. A method according to claim 16 including flowing the thermal medium exiting at the trailing edge of the wall at substantially the same angle as hot gases of combustion exit the trailing edge of the nozzle vane.

18. A method according to claim 16 wherein said passage extends in a serpentine manner between opposite sides of said segment and between leading and trailing edges thereof.

19. A method according to claim 16 including a joint between said cover and said wall along opposite sides of said segment, forming a pair of passages adjacent said joint and flowing the thermal medium through said pair of passages adjacent said joints.
